(19) United States
(12) Patent Application Publication
(10) Pub. No.: US 2006/0206360 A1
(43) Pub. Date: Sep. 14, 2006

(54) Medical information management apparatus and method, and medical information management program

(75) Inventor: Yasunori Ohta, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/367,314

(22) Filed: Mar. 6, 2006

(30) Foreign Application Priority Data
Mar. 11, 2005 (JP) 2005-069522

(51) Int. Cl. G06F 19/00; G06F 17/30

(52) U.S. Cl. 705/3; 707/6

(57) ABSTRACT

A medical information management apparatus for creating facile electronic medical charts by which patients can understand their medical conditions or diagnostic results by viewing their own medical charts. The apparatus includes: a managing unit for managing electronic medical chart data; a recording medium in which a dictionary file is recorded; a chart creating unit for extracting a medical term from an electronic medical chart of a certain patient, retrieving it in the dictionary file, and adding data representing associated explanation to the electronic medical chart data to create facile electronic medical chart data; an authenticating unit for authenticating the patient when the patient requests to view the electronic medical chart by operating a terminal; and a transmission control unit for transmitting the facile electronic medical chart data to the terminal to display description of the electronic medical chart to which the explanation has been added.

### BACKGROUND OF THE INVENTION

1. Field of the Invention

The present invention relates to a medical information management apparatus for managing description of diagnosis and treatment as electronic medical chart data in a medical facility, and further, to a medical information management method and medical information management program to be used in such a medical information management apparatus.

2. Description of a Related Art

In medical facilities such as clinics and general hospitals, medical charts (medical records) in which description of diagnosis and treatment is recorded are required to be stored for the purpose of knowing changes in medical conditions of patients, and should be stored for a predetermined period by law. Conventionally, since chart forms in which description of diagnosis and treatment is written with writing instruments are stored, securing of storage space, management work and retrieval work have imposed heavy burdens on the medical facilities.

On the other hand, in recent years, digitization in chart creation has been proceeding, and storage space can be reduced and management work and retrieval work can be saved by recording description of diagnosis and treatment as electronic medical chart data in recording media such as optical disks or magnetic disks.

Further, medical facilities, in which medical charts can be viewed or copied at patients' requests, have been increased, and patients are free to view their own medical charts by using an electronic medical chart system in such medical facilities. However, when the patients view medical charts created by doctors, it is difficult to understand the description of the medical charts because many medical terms are entered in the medical charts.

As a related technology, Japanese Patent Application Publication JP-P2003-288411A discloses a treatment method selection support method and a server capable of supporting selection of a treatment method by a patient, a treatment method selection support program and a computer-readable recording medium. In the treatment method selection support method, treatment information is input to the server and accumulated therein, and the server shows the accumulated treatment information to the patient, receives the treatment information selected from among the shown treatment information by the patient, and presents the received treatment information selected by the patient to a practitioner who treats the patient.

However, according to JP-P2003-288411A, the patient can view other patients' electronic medical charts, and therefore, in order to protect personal information of patients, the treatment information which patients can view is not the information recorded in the electronic medical charts created by doctors itself, but the information processed to such a degree as achieving a purpose of allowing the patients to select treatment methods. That is, it is a main purpose to prevent leak of personal information of patients or to extract information necessary for selection of the treatment methods from the electronic medical charts created by doctors to provide it to patients. There is no disclosure of specific technologies regarding conversion of terms into easy-to-understand expressions or addition of explanation of phrases.

Further, Japanese Patent Application Publication JP-P2002-117152A discloses a telemedicine network system and a provision method for efficiently providing to a traveler during a trip abroad mainly almost the same medical services as medical services within his own country. In this system, a doctor, who attempts to enter medical information into a database, enters medical information into the database in his native language or a language in which he usually writes medical records. The recorded data is normally read out in the recorded language, but if a doctor of another country wishes to view the medical records in his native language, he informs the wish to the database. In response, the database converts the medical records into a desired language and discloses them. In medical records, words to be used are limited to some degree such as names of diseases and symptoms. Further, there are medical terms common in all countries. Therefore, the conversion of medical records into other languages is relatively easy.

According to JP-P2002-117152A, for example, even when a person becomes ill abroad, a local doctor can properly grasp the previous medical history, etc. of the patient and appropriately treat the patient by translating an electronic medical chart into another language. However, the function of the system is only to translate the electronic medical charts and provide the translation.

### SUMMARY OF THE INVENTION

The present invention has been achieved in view of the above-mentioned problems. An object of the present invention is, in a medical information management apparatus for managing description of diagnosis and treatment as electronic medical charts, to create facile electronic medical charts, by which patients can understand their medical conditions or diagnostic results when viewing their own medical charts, separately from electronic medical charts created by doctors, and to maintain consistency in data between the original electronic chart and the facile electronic medical chart.

In order to achieve the object, a medical information management apparatus according to one aspect of the present invention is a medical information management apparatus for managing description of diagnosis and treatment as electronic medical charts in a medical facility and the apparatus includes: electronic medical chart managing means for accumulating and managing electronic medical chart data of plural cases in a database; a recording medium in which a dictionary file including medical terms in association with explanation thereof is recorded; facile electronic medical chart creating means for extracting a medical term from an electronic medical chart of a certain patient, retrieving the extracted medical term in the dictionary file, and adding data representing explanation associated with the retrieved medical term to the electronic medical chart data so as to create facile electronic medical chart data of the patient; authenticating means for authenticating the patient when the patient requests to view the electronic medical chart by operating a terminal; and transmission control means for transmitting the facile electronic medical chart data of the patient to the terminal such that description of the electronic medical chart, to which the explanation has been added, is displayed on a display unit of the terminal.

Further, a medical information management method according to one aspect of the present invention is a medical information management method of managing description of diagnosis and treatment as electronic medical charts in a medical facility, and the method includes the steps of: (a) authenticating a certain patient when the patient requests to view an electronic medical chart by operating a terminal; (b) extracting a medical term from the electronic medical chart of the patient; (c) retrieving the medical term extracted at step (b) in a dictionary file including medical terms in association with explanation thereof; (d) adding data representing explanation associated with the medical term retrieved at step (c) to electronic medical chart data so as to create facile electronic medical chart data of the patient; and (e) transmitting the facile electronic medical chart data created at step (d) to the terminal such that description of the electronic medical chart, to which the explanation has been added, is displayed on a display unit of the terminal.

Furthermore, a medical information management program according to one aspect of the present invention is a medical information management program for managing description of diagnosis and treatment as electronic medical charts in a medical facility, and the program actuates a CPU to execute the procedures of: (a) authenticating a certain patient when the patient requests to view an electronic medical chart by operating a terminal; (b) extracting a medical term from the electronic medical chart of the patient; (c) retrieving the medical term extracted at procedure (b) in a dictionary file including medical terms in association with explanation thereof; (d) adding data representing explanation associated with the medical term retrieved at procedure (c) to electronic medical chart data so as to create facile electronic medical chart data of the patient; and (e) transmitting the facile electronic medical chart data created at procedure (d) to the terminal such that description of the electronic medical chart, to which the explanation has been added, is displayed on a display unit of the terminal.

According to the present invention, the facile electronic medical chart data is created by extracting a medical term from the electronic medical chart data of a patient and adding data representing the explanation associated with the medical term retrieved in the dictionary file to the electronic medical chart data, and therefore, patients can understand their medical conditions or diagnostic results when viewing their own medical chart, and the consistency in data can be maintained between the original electronic chart and the facile electronic medical chart. Thereby, even if description is falsified in one of the original electronic chart and the facile electronic medical chart, the falsification can be reliably found.

### BRIEF DESCRIPTION OF THE DRAWINGS

FIG. 1 is a schematic diagram showing a medical information management system including a medical information management apparatus according to one embodiment of the present invention;

FIG. 2 is a block diagram showing a constitution of an electronic medical chart management terminal included in the medical information management apparatus according to the one embodiment of the present invention;

FIG. 3 shows a first form of medical chart (a medical record in Japan);

FIG. 4 shows a second form of medical chart (a medical record in Japan);

FIG. 5 shows a display example on the screen of the facile electronic medical chart to which explanation of medical terms has been added;

FIG. 6 shows a display example on the screen of the facile electronic medical chart using an URL;

FIG. 7 shows a display example on the screen of the facile electronic medical chart in which the explanation is displayed based on the URL; and

FIG. 8 is a flowchart showing an operation of the medical information management apparatus according to the one embodiment of the present invention.

### DESCRIPTION OF THE PREFERRED EMBODIMENTS

Hereinafter, preferred embodiments of the present invention will be described in detail by referring to the drawings. The same reference numerals are assigned to the same component elements and the description thereof will be omitted.

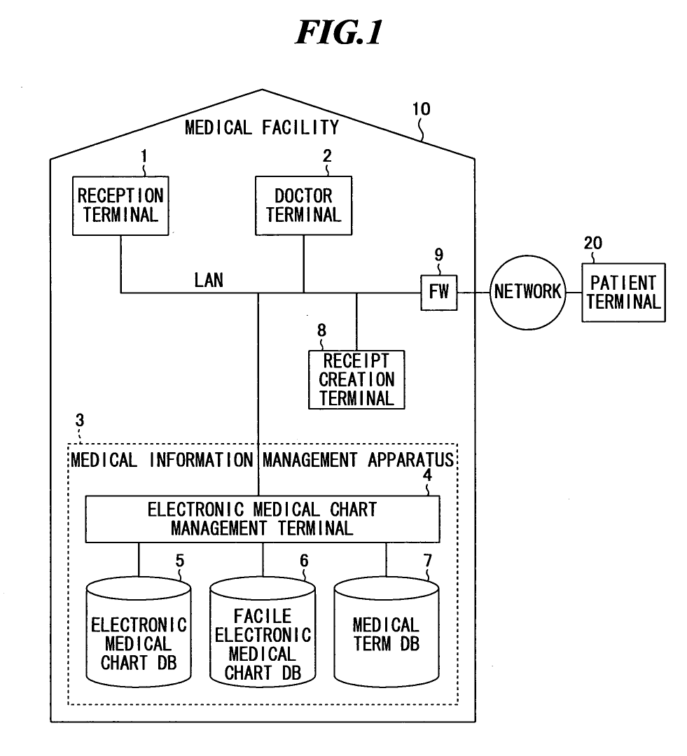

FIG. 1 is a schematic diagram showing a medical information management system including a medical information management apparatus according to one embodiment of the present invention. As shown in FIG. 1, in a medical facility 10 such as a clinic or general hospital, a reception terminal 1 to be used at the time of reception of patients, a doctor terminal 2 to be used by a doctor to enter description of diagnosis and treatment, a medical information management apparatus 3 for managing medical information, a receipt creation terminal 8 for creating receipts, and a firewall (FW) 9 for preventing unauthorized access are connected to one another via a LAN (local area network).

In the embodiment, the medical information management apparatus 3 creates facile electronic medical chart data, to which explanation has been added for patients to view, based on original electronic medical charts. Therefore, patients can understand their medical conditions and diagnostic results by viewing their own medical charts, and consistency in data is maintained between the original electronic charts and the facile electronic medical charts.

For the purpose, patient terminals 20 to be used by patients for viewing their own electronic medical charts are connected to the firewall (FW) 9 of the medical information management apparatus 3 via a network such as a dedicated line, a public switched telephone network (PSTN), the Internet, or the like. Since ordinary computers are available for the patient terminals 20, patients can access the medical information management apparatus 3 from home or workplaces. By the way, the patient terminals 20 may be provided in the medical facility 10.

The medical information management apparatus 3 includes an electronic medical chart management terminal 4 for managing description of diagnosis and treatment as electronic medical chart data, a recording medium in which an electronic medical chart database (DB) 5 for accumulating electronic medical chart data of plural cases, a recording medium in which a facile electronic medical chart database (DB) 6 for accumulating facile electronic medical chart data of plural cases is recorded, and a recording medium in which a medical term database (DB) 7 for accumulating medical terms and explanation thereof described in medical dictionaries etc. is recorded. By the way, the receipt creation terminal 8 may be omitted by additionally providing a function for creating receipts to the electronic medical chart management terminal 4.

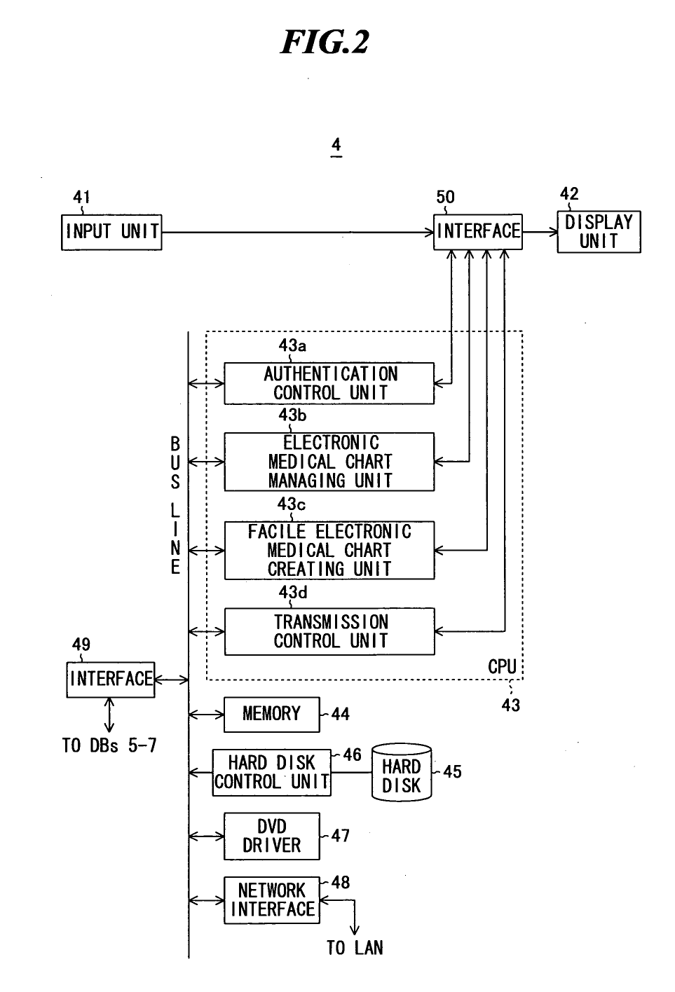

FIG. 2 is a block diagram showing a constitution of an electronic medical chart management terminal included in the medical information management apparatus according to the one embodiment of the present invention. The electronic medical chart management terminal 4 includes an input unit 41 to be used for inputting various kinds of instructions etc., a display unit 42 such as a CRT or LCD display for displaying images for operation etc., a central processing unit (hereinafter, referred to as CPU) 43 to which the input unit 41 and the display unit 42 are connected via an interface 50, a memory 44, a hard disk 45, a hard disk control unit 46 for controlling writing and reading of data in the hard disk 45, a DVD (digital versatile disk) driver 47 for performing writing and reading of data on a DVD, a network interface 48 for connection to a LAN, and an interface 49 for access to various databases. These parts 43 to 49 are connected to one another via a bus line.

In the hard disk 45, software (medical information management program) for actuating the CPU 43 to perform operation is recorded. As the recording medium for recording the software, not only the built-in hard disk 45, but also a DVD-ROM, a CD-ROM, an external hard disk, a flexible disk, an MO, an MT, a RAM, or the like may be used.

Next, function blocks 43a to 43d formed by the CPU 43 and software (medical information management program) will be described.

In the medical information management apparatus 3, in order to prevent leaks of personal information, falsification of medical image data and so on, an authentication is requested to access to the medical information, and access to the medical information is inhibited until it is allowed by the authentication. When the reception terminal 1, the doctor terminal 2, or the patient terminal 20 shown in FIG. 1 makes inquiries about access right to the medical information management apparatus 3, an authentication control unit 43a of the electronic medical chart management terminal 4 starts to authenticate and permit authorized terminals to make access.

The electronic medical chart managing unit 43b creates a new electronic medical chart and stores it in the electronic medical chart database 5 (FIG. 1) according to the operation of a doctor or the like using the input unit 41, and manages electronic medical chart data of plural cases stored in the electronic medical chart database 5. In the case where electronic medical charts stored in the medical facility are searched, the electronic medical chart managing unit 43b searches for an electronic medical chart of a requested case.

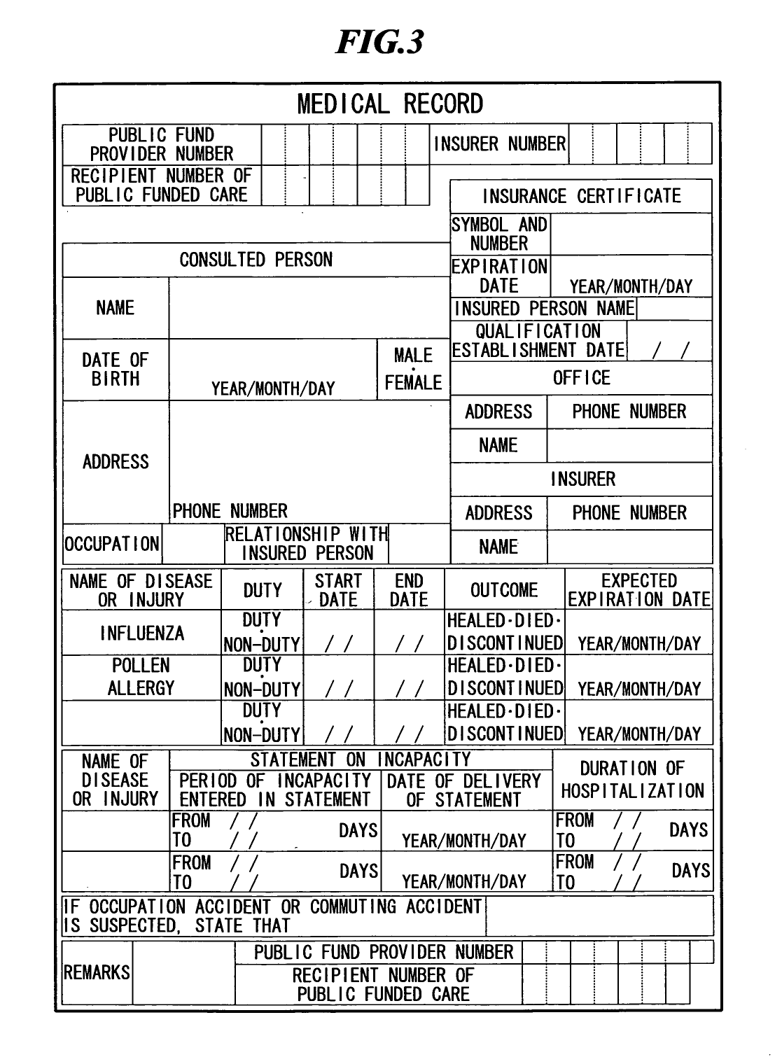

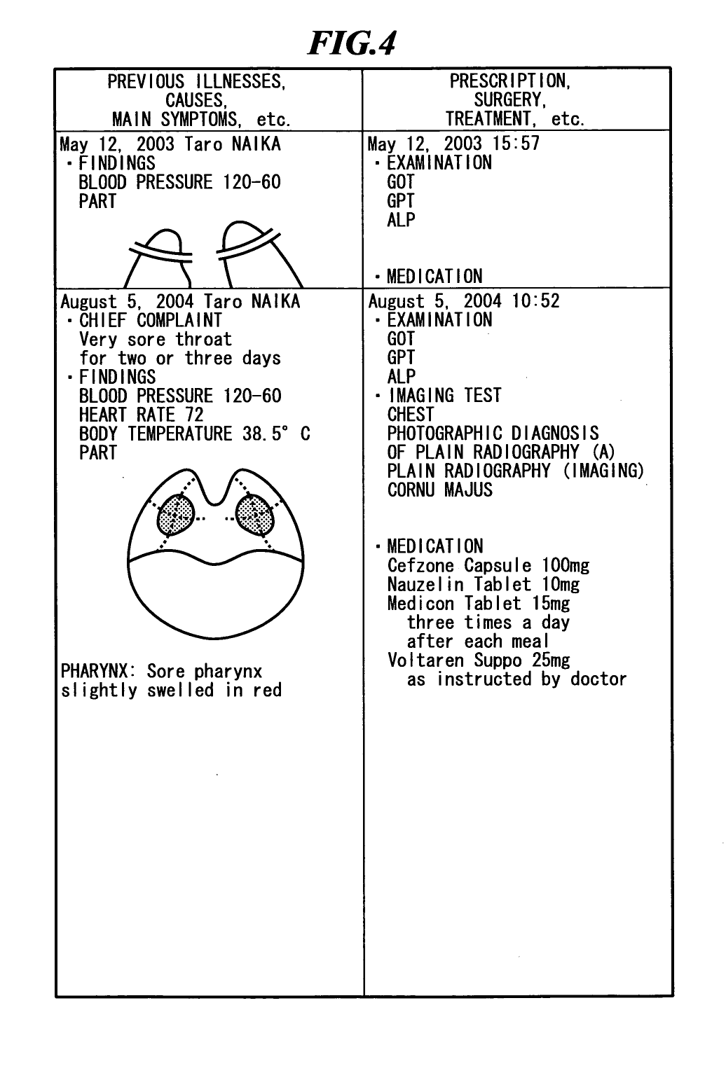

FIG. 3 shows a first form of medical chart (a medical record in Japan). As shown in FIG. 3, the medical chart includes public fund provider number, recipient number of public funded care, insurer number, insurance certificate symbol and number, etc. as items required to be entered on insurance medical institution's responsibility, and includes name of disease or injury, start date, end date, outcome, etc. as items required to be entered on insurance doctor's responsibility. As a name of disease or injury, a name of disease such as “influenza” or “pollen allergy” is entered. Further, FIG. 4 shows a second form of medical chart (a medical record in Japan). As shown in FIG. 4, a doctor enters the medical conditions, diagnostic results, etc. of a patient into the medical chart at medical examination and treatment of the patient.

However, since only description necessary and sufficient for medical experts is entered and a lot of medical terms are entered in the medical charts, when patients view the medical charts created by doctors, it is difficult for the patients to understand the description of the medical charts.

Accordingly, in the embodiment, after a request of viewing an electronic medical chart is made by a patient, a facile electronic medical chart creating unit 43c (FIG. 2) creates facile electronic medical chart data of the patient. Alternatively, the facile electronic medical chart creating unit 43c may create or edit a facile electronic medical chart when a doctor creates or edits an electronic medical chart. In the latter case, if it is ensured that the doctor edits the facile electronic medical chart when the doctor edits the electronic medical chart, the consistency in data can be maintained between the electronic charts and the facile electronic medical charts.

The facile electronic medical chart creating unit 43c creates the facile electronic medical chart data by extracting at least one medical term from the electronic medical chart of the case by referring to the medical term database 7 (FIG. 1), retrieving the extracted at least one medical term in the dictionary file, and adding data representing explanation associated with the retrieved at least one medical term to the electronic medical chart data. Alternatively, at the time of extraction of at least one medical term, the facile electronic medical chart creating unit 43c may automatically extract at least one medical term from the electronic medical chart of the case in accordance with preset automatic extraction conditions.

For example, as shown in FIG. 4, when medical terms such as “GOT”, “GPT”, and “ALP” are entered in an electronic medical chart, the facile electronic medical chart creating unit 43c creates facile electronic medical chart data by extracting the terms “GOT”, “GPT” and “ALP” in accordance with preset automatic extraction conditions, and adding data representing a character string of “glutamic-oxaloacetic transaminase” as explanation of the term “GOT”, adding data representing a character string of “glutamic-pyruvic transaminase” as explanation of the term “GPT”, and adding data representing a character string of “alkaline phosphatase” as explanation of the term “APT” by referring to the medical term database 7.

The created facile electronic medical chart data is transmitted from a transmission control unit 43d via the network interface 48 to the patient terminal 20 in response to the request from the patient, and description of the facile electronic medical chart is displayed on the patient terminal 20 and viewed by the patient. Further, the created facile electronic medical chart is accumulated in the facile electronic medical chart database 6.

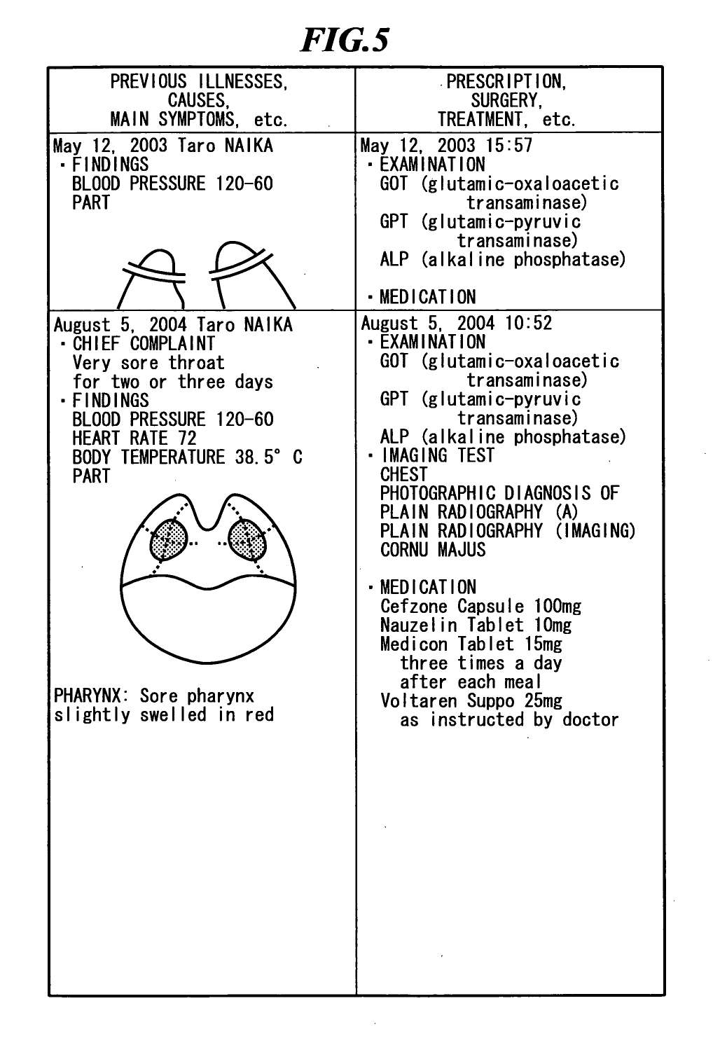

FIG. 5 shows a display example on the screen of the facile electronic medical chart to which explanation of medical terms has been added. As shown in FIG. 5, after the medical terms “GOT”, “GPT” and “ALP”, explanation of the terms are inserted in parentheses.

Alternatively, the facile electronic medical chart creating unit 43c may acquire storage location information of the explanation associated with the extracted medical term in the medical term database 7, and relate the storage location information as a link to the medical term in the form of URL (uniform resource locator) such that the explanation of the medical term may be referred to based on the URL.

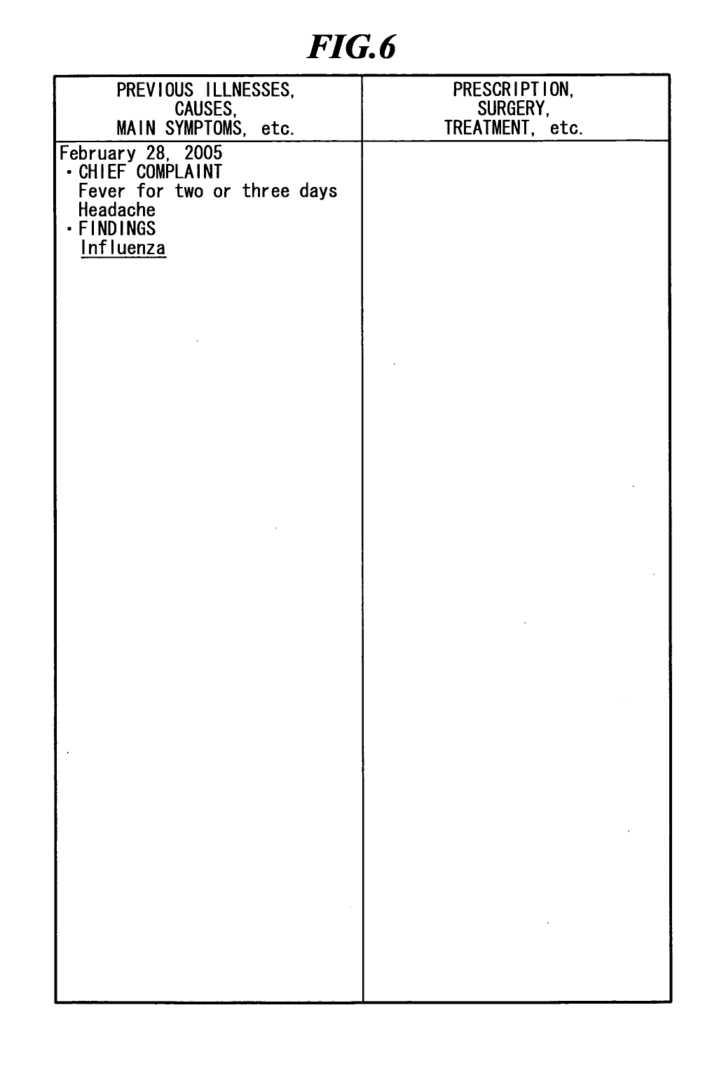

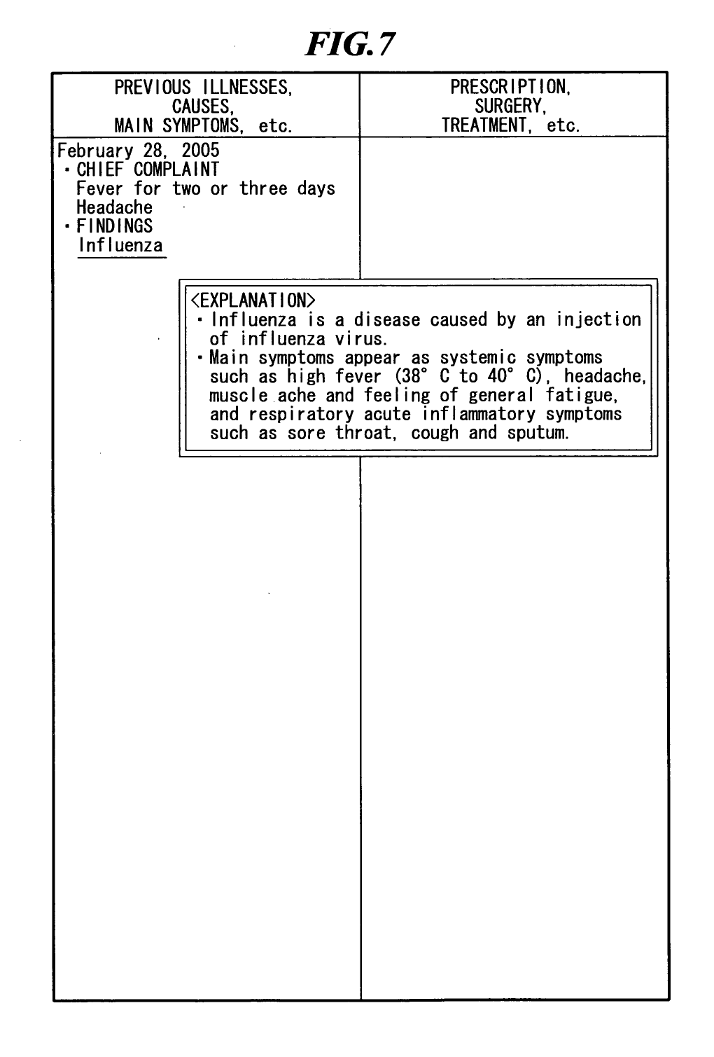

FIG. 6 shows a display example on the screen of the facile electronic medical chart using an URL, and FIG. 7 shows a display example on the screen of the facile electronic medical chart in which the explanation is being displayed based on the URL. In the screen of the facile electronic medical chart shown in FIG. 6, the medical term “influenza” is underlined and it is seen that the “influenza” is linked to its explanation. When a patient clicks or double-clicks “influenza”, the explanation of “influenza” is displayed on the screen as shown in FIG. 7.

Alternatively, the facile electronic medical chart creating unit 43c has added to medical terms the explanation thereof, the explanation associated with the medical term may be displayed while the patient place the mouse pointer on the character string of the medical term on the screen. That is, in the selected medical terms, the explanation thereof has been embedded by using a programming language (e.g., Visual Basic for Applications, Hyper Text Markup Language, etc.), the explanation embedded in the medical term is displayed as a pop-up hint while the mouse pointer is placed on the character string of the medical term on the screen. Here, the pop-up hint refers to a function, when the mouse pointer is placed on a particular character string or symbol, of displaying a simple explanation of the character string or symbol.

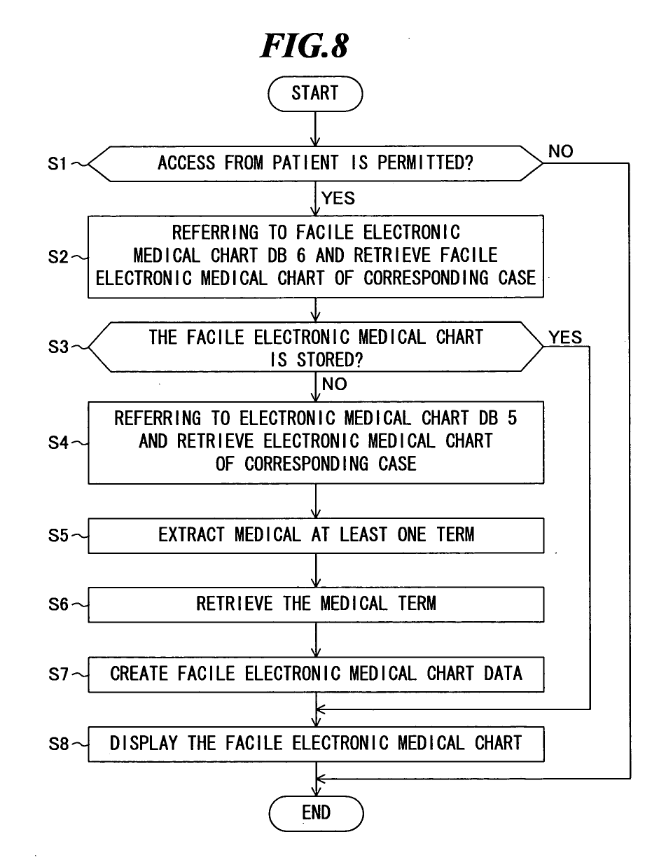

Next, an operation of the medical information management apparatus according to the embodiment will be described by referring to FIGS. 1, 2, and 8. FIG. 8 is a flowchart showing the operation of the medical information management apparatus according to the embodiment.

When a patient requests to view an electronic medical chart by operating the patient terminal 20, then at step S1 the authentication control unit 43a of the electronic medical chart management terminal 4 authenticates the patient and determines whether or not the unit permits the access. After the access is permitted, in response to the request of viewing the electronic medical chart at step S2, the facile electronic medical chart creating unit 43c retrieves a facile electronic medical chart of the corresponding case by referring to the facile electronic medical chart database 6.

At step S3, the facile electronic medical chart creating unit 43c determines whether or not the facile electronic medical chart data of the corresponding case is stored in the facile electronic medical chart database 6. If the facile electronic medical chart is stored, the process moves to step S8, while if the facile electronic medical chart is not stored, the process moves to step S4.

At step S4, the electronic medical chart managing unit 43b retrieves the facile electronic medical chart of the corresponding case by referring to the electronic medical chart database 5. At step S5, the facile electronic medical chart creating unit 43c extracts at least one medical term from the electronic medical chart of the corresponding case retrieved by the electronic medical chart managing unit 43b based on the preset extraction condition. Here, the condition for extracting medical terms from the electronic medical chart created by a doctor can be changed according to the name of injury or disease entered in a column of the name of injury or disease, a number of terms stored in the medical term database 7, etc.

At step S6, the facile electronic medical chart creating unit 43c retrieves the extracted at least one medical term in the dictionary files by referring to the dictionary files contained in the medical term database 7, and reads out explanation associated with the retrieved at least one medical term. At step S7, the facile electronic medical chart creating unit 43c adds the readout explanation to the electronic medical chart data so as to create facile electronic medical chart data of the patient.

At step S8, only if the access is authenticated, the transmission control unit 43d transmits the facile electronic medical chart data created by the facile electronic medical chart creating unit 43c to the patient terminal 20, and thereby, description of the electronic medical chart, to which the explanation has been added, is displayed on a display unit of the patient terminal 20.

Alternatively, when a doctor creates or edits an electronic medical chart, the facile electronic medical chart creating unit 43c may simultaneously create or edit a facile electronic medical chart. In this case, since a request of viewing the facile electronic medical chart is made by the patient after the facile electronic medical chart is created or edited, step S1 moves to between the steps S7 and S8 in FIG. 8.

For example, when a doctor operates the doctor terminal 2 or the electronic medical chart management terminal 4 to input patient information and treatment information for creating an electronic medical chart of a new case, the electronic medical chart managing unit 44b creates an electronic medical chart of the new case and stores it in the electronic medical chart database 5, and the facile electronic medical chart creating unit 43c creates a facile electronic medical chart of the new case and stores it in the facile electronic medical chart database 6.

Further, in the case where the medical examination or treatment with respect to the injury or disease of a patient who had visited the hospital is continued, when the doctor operates the doctor terminal 2 or the electronic medical chart management terminal 4 to add information on the medical examination or treatment to edit the electronic medical chart of the old case, the electronic medical chart managing unit 44b edits the electronic medical chart of the old case and stores it in the electronic medical chart database 5, and the facile electronic medical chart creating unit 43c edits the facile electronic medical chart of the old case and stores it in the facile electronic medical chart database 6.

1. A medical information management apparatus for managing description of diagnosis and treatment as electronic medical charts in a medical facility, said apparatus comprising:
electronic medical chart managing means for accumulating and managing electronic medical chart data of plural cases in a database;
a recording medium in which a dictionary file including medical terms in association with explanation thereof is recorded;
facile electronic medical chart creating means for extracting a medical term from an electronic medical chart of a certain patient, retrieving the extracted medical term in said dictionary file, and adding data representing explanation associated with the retrieved medical term to the electronic medical chart data so as to create facile electronic medical chart data of the patient;
authenticating means for authenticating the patient when the patient requests to view the electronic medical chart by operating a terminal; and
transmission control means for transmitting the facile electronic medical chart data of the patient to said terminal such that description of the electronic medical chart, to which the explanation has been added, is displayed on a display unit of said terminal.

2. A medical information management apparatus according to claim 1, wherein said facile electronic medical chart creating means creates the facile electronic medical chart data of the patient after receiving a request of viewing the electronic medical chart from the patient.

3. A medical information management apparatus according to claim 1, wherein said facile electronic medical chart creating means creates and/or edits the facile electronic medical chart when a doctor creates and/or edits the electronic medical chart.

4. A medical information management apparatus according to claim 1, wherein said facile electronic medical chart creating means creates the facile electronic medical chart data such that, after the medical term, a character string including the explanation thereof is inserted and displayed in the facile electronic medical chart.

5. A medical information management apparatus according to claim 1, wherein said facile electronic medical chart creating means relates a character string including the explanation to the medical term as a link such that, when the medical term is clicked with a mouse pointer, the character string including the explanation thereof is displayed in the facile electronic medical chart.

6. A medical information management apparatus according to claim 1, wherein said facile electronic medical chart creating means adds a character string including the explanation to the medical term such that, when a mouse pointer is laid on the medical term, the character string including the explanation thereof is displayed in the facile electronic medical chart.

7. A medical information management method of managing description of diagnosis and treatment as electronic medical charts in a medical facility, said method comprising the steps of:
(a) authenticating a certain patient when the patient requests to view an electronic medical chart by operating a terminal;
(b) extracting a medical term from the electronic medical chart of the patient;
(c) retrieving the medical term extracted at step (b) in a dictionary file including medical terms in association with explanation thereof;
(d) adding data representing explanation associated with the medical term retrieved at step (c) to electronic medical chart data so as to create facile electronic medical chart data of the patient; and
(e) transmitting the facile electronic medical chart data created at step (d) to said terminal such that description of the electronic medical chart, to which the explanation has been added, is displayed on a display unit of said terminal.

8. A medical information management method of managing description of diagnosis and treatment as electronic medical charts in a medical facility, said method comprising the steps of:
(a) extracting a medical term from an electronic medical chart of a certain patient;
(b) retrieving the medical term extracted at step (b) in a dictionary file including medical terms in association with explanation thereof;
(c) adding data representing explanation associated with the medical term retrieved at step (b) to electronic medical chart data so as to create facile electronic medical chart data of the patient;
(d) authenticating the patient when the patient requests to view the electronic medical chart by operating a terminal; and
(e) transmitting the facile electronic medical chart data created at step (d) to said terminal such that description of the electronic medical chart, to which the explanation has been added, is displayed on a display unit of said terminal.

9. A medical information management program for managing description of diagnosis and treatment as electronic medical charts in a medical facility, said program actuating a CPU to execute the procedures of:
(a) authenticating a certain patient when the patient requests to view an electronic medical chart by operating a terminal;
(b) extracting a medical term from the electronic medical chart of the patient;
(c) retrieving the medical term extracted at procedure (b) in a dictionary file including medical terms in association with explanation thereof;
(d) adding data representing explanation associated with the medical term retrieved at procedure (c) to electronic medical chart data so as to create facile electronic medical chart data of the patient; and
(e) transmitting the facile electronic medical chart data created at procedure (d) to said terminal such that description of the electronic medical chart, to which the explanation has been added, is displayed on a display unit of said terminal.

10. A medical information management program for managing description of diagnosis and treatment as electronic medical charts in a medical facility, said program actuating a CPU to execute the procedures of:
(a) extracting a medical term from an electronic medical chart of a certain patient;
(b) retrieving the medical term extracted at procedure (b) in a dictionary file including medical terms in association with explanation thereof;
(c) adding data representing explanation associated with the medical term retrieved at procedure (b) to electronic medical chart data so as to create facile electronic medical chart data of the patient;
(d) authenticating the patient when the patient requests to view the electronic medical chart by operating a terminal; and
(e) transmitting the facile electronic medical chart data created at procedure (d) to said terminal such that description of the electronic medical chart, to which the explanation has been added, is displayed on a display unit of said terminal.
